(19) United States
(12) Patent Application Publication
(10) Pub. No.: US 2008/0087447 A1
(43) Pub. Date: Apr. 17, 2008

(54) Control and method of control for an earthmoving system

(76) Inventor: Richard Paul Piekutowski, Huber Heights, OH (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/581,605

(22) Filed: Oct. 16, 2006

(51) Int. Cl. A01B 67/00

(52) U.S. Cl. 172/3

(57) ABSTRACT

An earthmoving system includes a laser transmitter for transmitting a reference beam of laser light, and a bulldozer having a laser receiver mounted on the bulldozer for sensing the laser light. The earthmoving system further includes a frame and a cutting blade supported by a blade support extending from the frame. The blade support has a pair of hydraulic cylinders for raising and lowering the blade in relation to the frame. A gyroscopic position sensor senses rotation of the frame about an axis generally transverse to the bulldozer and passing through the center of gravity of the bulldozer. The control is responsive to the laser receiver and to the gyroscopic orientation sensor, and controls the operation of the cylinders and the position of the cutting blade.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to an earthmoving system of the type that incorporates a bulldozer for grading or leveling a tract of land to a desired finish contour and, more particularly to an earthmoving system in which the control system for the earthmoving apparatus is continually updated during the grading process as to the position of the cutting blade of the bulldozer.

Various control arrangements have been developed to control earthmoving devices, such as bulldozers, so that a tract of land can be graded to a desired height or contour. A number of systems have been developed in which the position of the earthmoving apparatus is determined with a laser, GPS or optically referenced positioning system. In such systems, a tract of land is surveyed and a site plan is drawn up with the desired finish contour. From the tract survey and the site plan, a cut-fill map is produced showing amounts of cut or fill needed in specific areas of the tract of land to produce the desired finish contour. The information is then stored in the computer control system on the earthmoving apparatus.

The earthmoving apparatus has a position reference receiver, such as a laser receiver, which is coupled to the grading implement or cutting blade. The laser receiver may intercept a reference beam of laser light that is projected from a transmitter and that rotates in a plane above the tract of land. The beam provides vertical position information to the machine control system. The x and y position information may be determined by other reference beams, by a GPS system, or by other navigation techniques. The vertical intercept point of the laser beam on the laser receiver, which is indicative of elevation of the grading implement, is provided to the computer control system, which calculates elevation error of the grading implement based on the cut-fill map and the detected planar position of the apparatus. The elevation error may be displayed for the operator of the earthmoving apparatus who can then make the appropriate adjustments manually. Alternatively, the computer may automatically adjust the elevation of the grading implement to reduce elevation error.

One limitation encountered with such systems is that the beam of laser light defining the reference plane rotates at a relatively slow rate, e.g. on the order of 10 rotations per second. As a consequence, the computer control system is only able to determine the position of the machine and, most importantly, the vertical position of the cutting blade relatively slowly; typically about once each 1/10th second. This is less frequent than might otherwise be preferred. It has been found that bulldozers, especially, are subject to errors that result from rocking fore and aft as they travel over the rough terrain of a job site that is still in the process of being contoured. Generally, this rocking occurs about an axis that extends laterally with respect to the bulldozer and through the center of gravity of the bulldozer. Monitoring the movement of the bulldozer between laser beam strikes on the receiver permits the position of the cutting blade to be controlled with greater precision and allows for better finishing of the construction site. A second limitation occurs when periodic updates of position from the reference are blocked or missed by the receiver. The proposed solution allows the control system to work for a limited period of time without the reference.

It is seen that there is a need, therefore, for an earthmoving system and method having a bulldozer or other machine and including a control in which compensation is made for inaccuracies in cutting blade position that would otherwise result from the rotation of the frame of the bulldozer about an axis that is perpendicular to the longitudinal axis of the bulldozer and that passes through the center of gravity of the bulldozer; and for such an earthmoving system and method in which compensation may be provided at a rate which exceeds the rotation or update rate of the laser transmitter that the system uses to determine cutting blade position.

### SUMMARY OF THE INVENTION

These needs are met by an earthmoving system according to the present invention, which includes a laser transmitter for transmitting a reference beam of laser light, and a bulldozer having a laser receiver mounted thereon for sensing the laser light. The earthmoving system further comprises a frame and a cutting blade supported by a blade support, extending from the frame. The blade support includes a pair of hydraulic cylinders for raising and lowering the blade in relation to the frame. A gyroscopic position sensor senses rotation of the frame about an axis generally transverse to the earthmoving machine and passing through the center of gravity of the machine. A control is responsive to the laser receiver and to the gyroscopic orientation sensor, and controls the operation of the cylinders and the position of the cutting blade.

The laser transmitter projects a rotating beam of laser light, and the control determines the position of the cutting blade based upon the output of the gyroscopic position sensor. The control periodically updates the actual position of the cutting blade based upon illumination of the laser receiver by the laser transmitter, allowing correction of any gyroscope-based sensor error that may have accumulated since the previous position sensor input.

The earthmoving system further comprises an angle sensor sensing the relative position between the blade support and the frame. Alternatively, a means of measuring cylinder displacement can be used in conjunction with known machine geometry to determine the equivalent relative angle between the blade arm and the frame. The control is responsive to the angle sensor and determines the position of the cutting blade based upon the output of the angle sensor and the output of the gyroscopic position sensor more often than the control determines the position of the cutting blade based upon the output of the laser receiver. The control determines the position of the cutting blade each time the receiver is illuminated by the rotating beam. The earthmoving system may also include a reference position system, such as a GPS system, for determining the position of the bulldozer. The bulldozer has a frame and a cutting blade supported by a blade support extending from said frame. The blade support includes a pair of hydraulic cylinders for raising and lowering said blade in relation to the frame. A gyroscopic position sensor senses rotation of the frame about an axis generally transverse to the bulldozer and passing through the center of gravity of said bulldozer. A control is responsive to the reference position system and to the gyroscopic orientation sensor, for controlling the operation of said cylinders and thereby the position of said cutting blade.

A method, according to the present invention, for determining the position of the cutting blade of a bulldozer meets these needs, as well. The method utilizes a bulldozer or other machine having a frame and the cutting blade. The cutting blade is supported by a blade support extending from the frame. The blade support includes a pair of hydraulic cylinders for raising and lowering the blade in relation to the frame. The location of the cutting blade is periodically determined by sensing the relative position of a reference beam of laser light using a laser receiver mounted on the bulldozer.

The rotation of the frame about an axis that is generally transverse to the machine and that passes through the center of gravity of the machine is sensed using a gyroscopic position sensor. The operation of the cylinders and the resulting position of the cutting blade are controlled, based upon the outputs from the gyroscopic position sensor. The actual position of the cutting blade is periodically updated based upon illumination of the laser receiver by the laser transmitter. The relative position between the blade support and the frame may be sensed using an angle sensor or alternative means, and the position of the cutting blade determined based upon the output of the gyroscopic position sensor and the output of the angle sensor. This determination may be made a plurality of times between each successive determination of the position of the cutting blade based upon the output of the laser receiver. The method may further include the steps of rotating a beam of laser light, sensing the rotating beam of laser light, and determining the position of the cutting blade.

It is an object of the present invention to provide a an earthmoving system and a method of operation an earthmoving system in which the location of cutting blade is determined, at least in part, by using the output of a gyroscopic position sensor, or by measuring the relative angle between the blade and the frame. Other objects and advantages of the invention will be apparent from the following description, the accompanying drawings, and the appended claims.

### BRIEF DESCRIPTION OF THE DRAWINGS

FIG. 1 is a side elevation view of an earthmoving system in accordance with the present invention; and

FIG. 2 is a block diagram of the control used in the earthmoving system of FIG. 1, in accordance with the present invention.

### DETAILED DESCRIPTION OF THE INVENTION

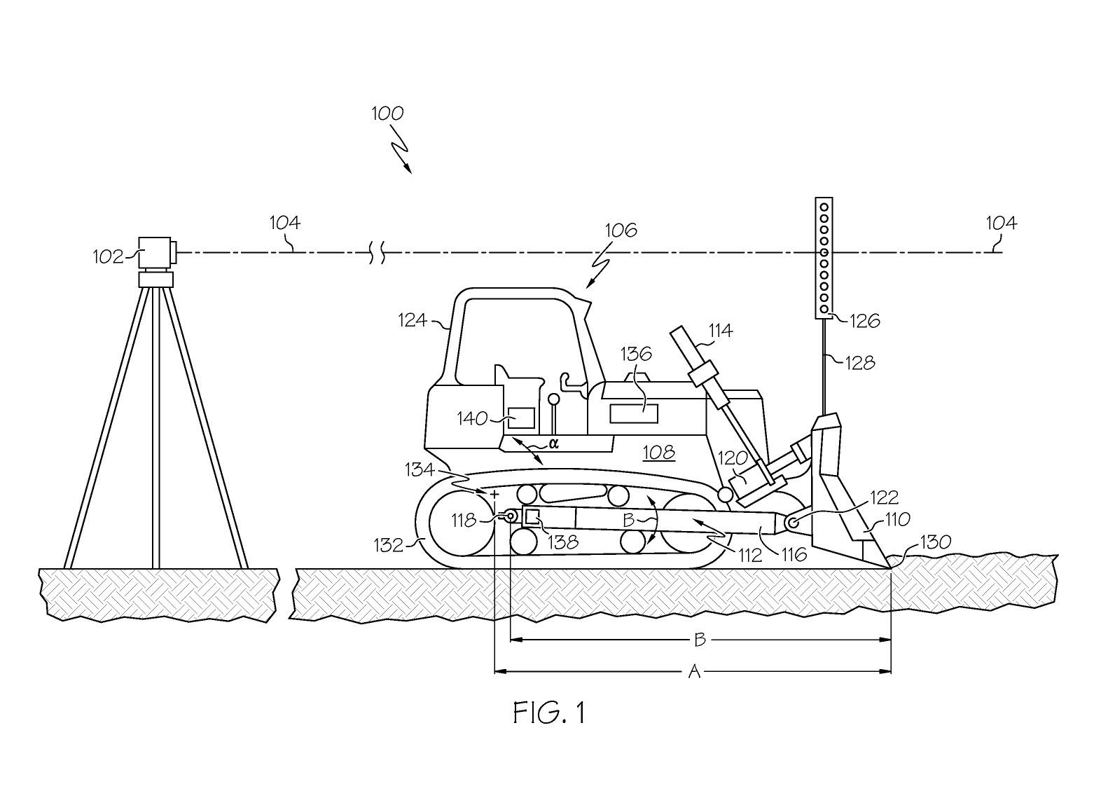

Reference is now made to FIG. 1, which illustrates an earthmoving system 100, constructed according to the present invention. The system 100 includes a laser transmitter 102 for transmitting a reference beam of laser light 104. The beam of laser light is rotated about a vertical axis to define a horizontal reference plane. As is known, the reference plane may be tilted at a precisely controlled angle to the horizontal if a grade is to be defined by the plane of light.

The system 100 further includes a bulldozer 106, having a frame 108 and a cutting blade 110. The cutting blade 110 is supported by a blade support 112 that extends from the frame 110. The blade support 112 includes a pair of hydraulic cylinders 114, only one of which is shown in FIG. 1, for raising and lowering the blade 110 in relation to the frame. The blade support 112 further includes a pair of arms 116, one of which is shown in FIG. 1, that are attached to opposite ends of blade 110 and pivotally attached to the frame 108 at 118. Cylinders 114 can be extended or retracted to lower or to raise blade 110 as arms 112 pivot about 118. Cylinders 120 extend between the top of blade 110 and arms 116 and may be used to pivot the blade about pivot connection 122. Bulldozer 106 has a cab 124 from which an operator may manually operate various controls to control the operation of the bulldozer.

The earthmoving system 100 further includes a laser receiver 126 mounted on the bulldozer 106 for sensing the rotating laser light reference beam 104. The receiver 126 is shown mounted on a mast 128, which extends upward from the blade 110. The receiver 126 detects the height of the beam 104, making it possible to determine the vertical height of the cutting edge 130 of cutting blade 110. The difficulty with relying only upon the laser receiver 126 for this information is that it is updated at a relatively slow rate. The transmitter 102 typically projects a beam of laser light that is rotated in a reference plane at frequency of perhaps 600 rpm. As a consequence, if the control system of the bulldozer 106 were to rely solely on the laser receiver 126 for a determination of the height of the blade 110, these measurements could only be made at the rate of 10 measurements per second.

As the bulldozer 106 moves forward, the frame 108 will typically be subjected to impact and vibrations though the cutting blade 110 and tracks 132 and changes in vertical position. As a consequence, the frame 108 may pitch forward and aft, in effect rotating about a generally horizontal axis, perpendicular to the direction of travel that extends through the center of gravity 134 of the bulldozer 106. This will, in turn, result in angular movement of the frame 108 and the balance of the bulldozer 106, including the blade 110, by an angle α. Further, vertical movement of the cutting blade 110 may also result from actuation of the cylinders 114 causing the arms 116 to pivot about the rear pivot point 118 with respect to frame 108, by an angle β. It will be noted that the resulting change in the elevation of the cutting blade 110 can be estimated as:

ΔElevation=Sin Δα×length A+Sin Δβ×length B,

where A and B are the lengths shown in FIG. 1. Note that if there is no relative movement between the arms 116 and the frame 108, the change in elevation will be a function of only Δα. Length A is the distance from the center of gravity 134 to the cutting edge 130, and length B is the distance from the pivot 118 to the cutting edge 130. Whereas attempting to estimate changes in vertical position of the blade from double integration of acceleration data at the blade is very difficult because of the wide variety in frequency and scale of input, it is much simpler to use single integration of the lower rate rotational motion directly measured by a gyroscope. The changes in vertical position measured in this fashion can be monitored at a substantially higher rate than the rotational input motions. These motions however can occur at a rate near the frequency of the reference system updates. As a consequence, monitoring the position of the blade 10 times per second using the receiver 126 may not provide sufficient opportunity for corrective action, resulting in a lack of precise elevation control.

The present invention monitors Δα and Δβ at a higher frequency and overcomes these difficulties. It should be appreciated, however, that monitoring and correcting for only Δα changes might be sufficient if the arms 116 are firmly held in position with respect to the frame 108, such that is there is no play in the support, and further if the speed of actuation of the cylinders 114 is limited to provide for slow movement and slow Δβ changes.

To monitor changes in Δα, a gyroscopic position sensor 136 mounted on the frame 108 senses the rotation of the frame 108 about an axis generally transverse to the bulldozer and passing through the center of gravity 134 of the bulldozer. The gyroscopic position sensor can be any one of a number of commercially available sensors. To monitor changes in Δβ, an angle encoder 138 may be provided on one of the arms 116, adjacent the pivot 118. The angle encoder can be any one of a number of commercially available encoders. Alternatively, changes in Δβ may be monitored by other sensors, such as a gyroscopic position sensor, or a sensor that detects the extension length of cylinder 114.

A control 140, typically located in cab 124, is responsive to the laser receiver 125 and to the gyroscopic orientation sensor 136, for controlling the operation of the cylinders 114 and thereby controlling the position of the cutting blade 110. In those systems in which Δβ is also monitored, the control 140 is also responsive to the angle encoder 138 for an indication of Δβ. The control 140 determines the position of the cutting blade 110 based upon the output of the gyroscopic position sensor 136, and the control 140 periodically updates the measured position of the cutting blade 110 based upon illumination of the laser receiver 126 by the laser transmitter 102. The angle sensor 138 senses the relative position between the blade support 112 and the frame 108. The control 140 determines the position of the cutting blade 110 based upon the output of the gyroscopic position sensor 136 and the output of the angle sensor 138. The control 140 preferably makes such a determination a plurality of times between successive determinations of the position of the cutting blade 110 based upon the output of the laser receiver 126.

Although the earthmoving apparatus 100 is illustrated as a bulldozer, any earthmoving machine using a blade or other grading implement to cut and fill soil can advantageously employ the present invention, as will be readily apparent to those skilled in the art from the present disclosure. For example, a motorgrader, a front end loader, skid steer, or a power shovel may utilize a control according to the present invention, although such a control may be of lesser importance, depending upon the stability or instability of the machine frame, and the speed of operation of the machine.

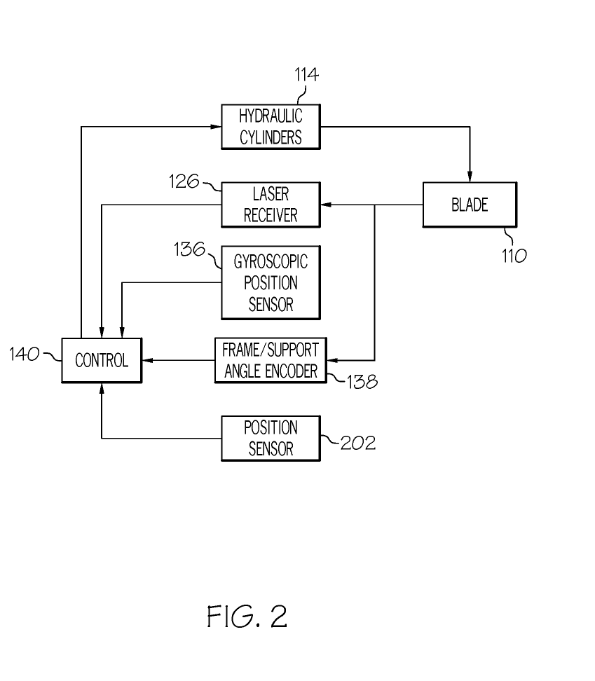

FIG. 2 illustrates the operation of the present invention. As will be appreciated, the method of operation relates to a method of determining the position of the cutting blade of a bulldozer having a frame and a cutting blade 110. The cutting blade 110 is supported by a blade support extending from the frame. The blade support includes a pair of hydraulic cylinders 114 for raising and lowering the blade 110 in relation to the frame. A position sensor 202, such as for example a GPS system, senses the x and y coordinates of the earthmoving apparatus on the work site, as the earthmoving apparatus moves about the worksite.

The control 140 receives x and y coordinate position information for the earthmoving apparatus from the position sensor 202. The position of the earthmoving system may then be visually displayed for the operator on a display in cab 124.

Control 140 also receives signals from the gyroscopic position sensor 136 and laser receiver 126. Periodically the system determines the vertical location of the cutting blade by sensing the relative position of a reference beam of laser light 104 using the laser receiver 126 or other vertical reference system, such as GPS.

Rotation of the frame 108 about an axis that is generally transverse to the bulldozer and that passes through the center of gravity of the bulldozer is sensed using gyroscopic position sensor 136. The operation of the cylinders 114 and the position of the cutting blade 110 are controlled based upon the output of the gyroscopic position sensor 136 and upon the periodically updated position of the cutting blade that is determined by measurement with respect to the beam 104 each time the laser receiver 126 is illuminated.

The method further includes the steps of sensing the relative position, angle β, between the blade support 112 and the frame 108 using an angle sensor, and determining the position of the cutting blade based upon the output of the gyroscopic position sensor and the output of the angle sensor. It will be appreciated that the output of the receiver 126 is limited to a prescribed number of measurements per unit time, and that this number coincides with the rotational rate of the transmitter 102, the GPS epoch period or the solution determination and communication rate of an optical robotic station.

Having thus described the earthmoving apparatus and method of the present invention in detail and by reference to preferred embodiments thereof, it will be apparent that modifications and variations are possible without departing from the scope of the invention defined in the appended claims.

What is claimed is:

1. An earthmoving system, comprising:
a laser transmitter for transmitting a reference beam of laser light,
a bulldozer, having a frame and a cutting blade supported by a blade support extending from said frame, said blade support including a pair of hydraulic cylinders for raising and lowering said blade in relation to said frame,
a laser receiver mounted on said bulldozer for sensing said laser light in said reference beam,
a gyroscopic position sensor for sensing rotation of said frame about an axis generally transverse to said bulldozer and passing through the center of gravity of said bulldozer, and
a control, responsive to said laser receiver and to said gyroscopic orientation sensor, for controlling the operation of said cylinders and thereby the position of said cutting blade.

2. The earthmoving system of claim 1, in which said laser transmitter projects a rotating beam of laser light, and in which said control determines the position of said cutting blade based upon the output of said gyroscopic position sensor, and in which said control periodically updates the actual position of said cutting blade based upon illumination of said laser receiver by said laser transmitter.

3. The earthmoving system of claim 2, further comprising an angle sensor sensing the relative position between said blade support and said frame, in which said control is further responsive to said angle sensor and determines the position of said cutting blade based upon the output of said gyroscopic position sensor and the output of said angle sensor, said control making such determination a plurality of times between successive determinations of the position of said cutting blade based upon the output of said laser receiver.

4. The earthmoving system of claim 1, in which said laser transmitter comprises a transmitter that provides a rotating beam of laser light, and in which said control determines the position of said cutting blade each time said receiver is illuminated by said rotating beam.

5. The earthmoving system of claim 4, in which said control determines the position of said cutting blade based upon the output of said gyroscopic position sensor.

6. The earthmoving system of claim 5, further comprising an angle sensor sensing the relative position between said blade support and said frame, and in which said control is further responsive to said angle sensor and determines the position of said cutting blade based upon the output of said gyroscopic position sensor and the output of said angle sensor.

7. An earthmoving system, comprising:
an earthmoving machine, having a frame and a cutting blade supported by a blade support extending from said frame, said blade support including a pair of hydraulic cylinders for raising and lowering said blade in relation to said frame,
an angle sensor sensing the relative position between said blade support and said frame,
a gyroscopic position sensor for sensing rotation of said frame about an axis generally transverse to said machine and passing through the center of gravity of said machine, and
a control, responsive to said angle sensor and to said gyroscopic position sensor, for detecting the change in position of the cutting blade and controlling the operation of said cylinders, thereby controlling the position of said cutting blade.

8. The earthmoving system of claim 7, further comprising a laser transmitter positioned at a known location and a laser receiver mounted on said machine, and in which said control periodically updates the actual position of said cutting blade based upon illumination of said laser receiver by said laser transmitter.

9. The earthmoving system of claim 8, in which said control determines the position of said cutting blade based upon the output of said gyroscopic position sensor and the output of said angle sensor, said control making such determination a plurality of times between successive determinations of the position of said cutting blade based upon the output of said laser receiver.

10. The earthmoving system of claim 7, in which said control determines the position of said cutting blade each time said receiver is illuminated by said rotating beam.

11. The earthmoving system of claim 10, in which said control determines the position of said cutting blade based upon the output of said gyroscopic position sensor.

12. A method of determining the position of the cutting blade of a bulldozer, said bulldozer having a frame and said cutting blade, said cutting blade supported by a blade support extending from said frame, said blade support including a pair of hydraulic cylinders for raising and lowering said blade in relation to said frame, comprising the steps of:
periodically determining the location of the cutting blade by sensing the relative position of a reference beam of laser light using a laser receiver mounted on said bulldozer,
sensing rotation of said frame about an axis that is generally transverse to said bulldozer and that passes through the center of gravity of said bulldozer using a gyroscopic position sensor, and
controlling the operation of said cylinders and thereby the position of said cutting blade based upon the output of said gyroscopic position sensor, and
periodically updating the actual position of said cutting blade based upon illumination of said laser receiver by said laser transmitter.

13. The method of determining the position of the cutting blade of a bulldozer according to claim 12, further comprising the steps of:
sensing the relative position between said blade support and said frame using an angle sensor, and
determining the position of said cutting blade based upon the output of said gyroscopic position sensor and the output of said angle sensor a plurality of times between each successive determination of the position of said cutting blade based upon the output of said laser receiver.

14. The method of determining the position of the cutting blade of a bulldozer according to claim 13, further comprising the steps of:
a rotating beam of laser light,
sensing the rotating beam of laser light, and
determining the position of the cutting blade.

15. The method of determining the position of the cutting blade of a bulldozer according to claim 13, further comprising the step of determining position of said cutting blade each time said receiver is illuminated by said rotating beam.

16. An earthmoving system, comprising:
a bulldozer, having a frame and a cutting blade supported by a blade support extending from said frame, said blade support including a pair of hydraulic cylinders for raising and lowering said blade in relation to said frame,
a reference position system for determining the position of the bulldozer,
a gyroscopic position sensor for sensing rotation of said frame about an axis generally transverse to said bulldozer and passing through the center of gravity of said bulldozer, and
a control, responsive to said reference position system and to said gyroscopic orientation sensor, for controlling the operation of said cylinders and thereby the position of said cutting blade.

17. The earthmoving system of claim 16, in which said control determines the position of said cutting blade based upon the output of said gyroscopic position sensor, and in which said control periodically updates the actual position of said cutting blade based upon the output from said reference position system.

18. The earthmoving system of claim 17, further comprising an angle sensor sensing the relative position between said blade support and said frame, in which said control is further responsive to said angle sensor and determines the position of said cutting blade based upon the output of said gyroscopic position sensor and the output of said angle sensor, said control making such determination a plurality of times between successive determinations of the position of said cutting blade based upon the output of said reference position system.

19. The earthmoving system of claim 18, in which said control determines the position of said cutting blade based upon the output of said gyroscopic position sensor.

20. The earthmoving system of claim 19, further comprising an angle sensor sensing the relative position between said blade support and said frame, and in which said control is further responsive to said angle sensor and determines the position of said cutting blade based upon the output of said gyroscopic position sensor and the output of said angle sensor.

21. A method of determining the position of the cutting blade of a bulldozer, said bulldozer having a frame and said cutting blade, said cutting blade supported by a blade support extending from said frame, said blade support including a pair of hydraulic cylinders for raising and lowering said blade in relation to said frame, comprising the steps of:
sensing rotation of said frame about an axis that is generally transverse to said bulldozer and that passes through the center of gravity of said bulldozer using a gyroscopic position sensor, and
controlling the operation of said cylinders and thereby the position of said cutting blade based upon the output of said gyroscopic position sensor, and
periodically updating the actual position of said cutting blade.

22. The method of determining the position of the cutting blade of a bulldozer according to claim 21, further comprising the steps of:
sensing the relative position between said blade support and said frame using an angle sensor, and
determining the position of said cutting blade based upon the output of said gyroscopic position sensor and the output of said angle sensor a plurality of times between each successive determination of the position of said cutting blade by other means.

23. The method of determining the position of the cutting blade of a bulldozer according to claim 22, further comprising the steps of:
a rotating beam of laser light,
sensing the rotating beam of laser light, and
determining the position of the cutting blade.

24. The method of determining the position of the cutting blade of a bulldozer according to claim 23, further comprising the step of determining position of said cutting blade each time said receiver is illuminated by said rotating beam.
